(19) United States
(12) Patent Application Publication
(10) Pub. No.: US 2002/0120516 A1
(43) Pub. Date: Aug. 29, 2002

(54) Mobile marketing method, mobile marketing system, mobile marketing server, and associated user terminal, analysis terminal, and program

(75) Inventors: Hidekazu Sakagami, Tokyo (JP); Rina Hayasaka, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/081,229

(22) Filed: Feb. 25, 2002

(30) Foreign Application Priority Data
Feb. 26, 2001 (JP) 2001-049901
Dec. 26, 2001 (JP) 2001-393071

(51) Int. Cl. G06F 17/60

(52) U.S. Cl. 705/14

(57) ABSTRACT

In a mobile marketing system, a mobile marketing server generates and distributes content that is suitable to a behavior in a user terminal and a user attribute, based on an action log, which includes a positions of a processing target user terminal and times at which the processing target user terminal existed at that position, and an attribute of a user of the processing target user terminal. A distribution log, which includes content IDs of distributed content, identifiers of user terminals to which distribution was made, and times of the distributions is managed, and when a notification occurs from an analysis terminal of a request for analysis, analysis is performed of a change in a behavior of a user at the time of distribution of content having the content ID, based on the managed action log and distribution log.

### BACKGROUND OF THE INVENTION

1 . Field of the Invention

The present invention relates to technology for distributing content to a user terminal that is movable, and more particularly to mobile marketing technology for distributing content with utilizing behaviors and attributes of a user having a terminal, as a distribution condition, and for calculating the behavior of a user after distribution as the result of the distribution.

2 . Related Art

When distributing content to a mobile user terminal in the past, content responsive to a user terminal behavior was distributed. Past technology of this type is known, as noted in the Japanese unexamined laid-open patent application 2000-46856. This will be referred to as the first prior art.

With conventional technology of the past, each user terminal sends position information indicating its position to a data processing apparatus, and the data processing apparatus accumulates the position information sent from the user terminal in time sequence manner. In doing this, the data processing apparatus also stores, with correspondence to the position information, inside which polygon (polygon number) the position indicated by the position information is disposed, when the target region is divided into a plurality of closed figures (polygons), and the position detection time or the like. After this is done, the data processing apparatus analyzes a behavior of a user terminal, based on the accumulated position information, position detection time, and the like. It then sends content to a user terminal having a behavior satisfying a prescribed condition, which is responsive to the satisfied condition. For example, with respect to a user terminal having a small amount of movement distance per unit time, pre-established content A is distributed, and with respect to a user terminal that has moved to a certain polygon, pre-established content B is distributed.

In addition to the above technology, the disclosure of the Japanese unexamined laid-open patent application H11-296546 is technology for distributing content responsive to a behavior of a user terminal, this being referred to hereinafter as the second prior art.

In the prior art noted in the above-noted reference, a position-drive type action support apparatus acquires current position information of a user terminal and, using the acquired current position information as a key, searches a position information/action point information database, in which the current position information and action point information indicating buildings, stations, and stores or the like, which are triggers for actions, are stored with correspondence therebetween. In a case in which it is possible to find action point information, this is used as a key to search an action point/action type database, in which are stored action type (content) with correspondence therebetween, so as to acquire the content to be distributed. Subsequently, the acquired content is distributed to the user terminal.

A technology related to a marketing system using position information is noted in the language of the Japanese unexamined patent publication (KOKAI) No. 2001-216450, which is referred to hereinafter as the third prior art.

In the third prior art, the assumption is made that the terminal of the user is provided with a wireless LAN communication function and that a plurality of wireless LAN apparatuses are installed in a store, a coupon being sent to a user who has entered the store, and whether or not the user has used the coupon or the case in which the user dwelled for a given period of time being acquired as marketing information.

Additionally, a marketing system that changes the information distribution rule by analysis of a customer behavior is disclosed in the Japanese unexamined patent publication (KOKAI) No. 11-66160, this being referred to hereinafter as the fourth prior art.

In this prior art, at an electronic marketing site mainly on the WWW (World Wide Web) a rule is generated which associates an attribute of a user who has decided to purchase a product with an attribute of the product, so that the corresponding product is recommended when a user having a similar attribute enters the store.

The prior art was insufficient for implementing a practical mobile marketing service, for the following three reasons.

1. It was not possible when controlling the distribution of information to a user to consider both the user attributes and the user behaviors as a distribution condition.

2. It was not possible to efficiently acquire the effectiveness of the information distribution from the user behaviors after information distribution.

3. It was not possible to provide a more effective distribution of information by feeding back the effect of information distribution to the control of the information distribution.

First, according to the above-described first and second prior arts, it is possible to distribute content to a user terminal responsive to a behavior of the user terminal, because only a behavior of the user terminal is considered, there is a problem of cases in which it is not possible to distribute content appropriate to a user. Specifically, even when the behaviors of user terminals are the same, there are cases in which it is necessary to select the content to be distributed in accordance with a particular user's attributes (for example, gender or age). With the prior art, however, because absolutely no consideration is given to user attributes, there were cases in which distributed content was not seen be the user as being appropriate.

In the third prior art, it is only possible to acquire the effect of the distribution of coupon in terms of whether or not the coupon was used. Additionally, while it was possible to acquire actions of each individual user after the distribution of information, it was not possible to efficiently determine the overall manner in which the distribution of information manifests itself, or to determine differences with respect to the actions of users to whom information was not distributed.

Additionally, in the fourth prior art, it was not possible to apply purchasing actions in the actual world. The reason for this is the difficulty of acquiring information on the act of purchasing in the real world, and the fact that there is a large amount of information in mobile marketing about customers who did not purchase, and existing systems were not able to utilize this information.

Accordingly, it is an object of the present invention to enable distribution of content using behaviors and attributes of a user having a user terminal as distribution conditions, and to enable calculation of the behaviors of a user after distribution as the effect of the distribution. An additional object of the present invention is to enable tuning of distribution rules using the obtained distribution effect, enabling effective information distribution, thereby enabling the implementation of a practical mobile marketing service.

### SUMMARY OF THE INVENTION

In order to achieve the above-noted object, a mobile marketing system according to the present invention generates content for distribution, by considering not only a behavior of a user terminal, but also user attributes (such as gender and age) of the user terminal.

More specifically, a mobile marketing server according to the present invention generates content to be distributed to a processing target user terminal, based on an action log, which includes positional information of the target user terminal and times when it existed at those positions, and user attributes of the user of the target user terminal, these being within a plurality of user terminals, which are movable (mobile) and which can communicate with the mobile marketing server, and further the mobile marketing server distributes the generated content to the processing target user terminal.

In a mobile marketing system according to the present invention, in order to enable analysis of a behavior of a user terminal, a mobile marketing server manages an action log, which includes the positional information of each user terminal and the times the user terminals existed at those positions, and when a notification of a request for analysis occurs from an analysis terminal, the behavior of a user terminal are analyzed, based on the thus managed action log, and the results of the analysis are sent to the analysis terminal.

In a mobile marketing system present invention, in order to enable analysis of a change in a behavior of a user terminal when a certain content is distributed, the mobile marketing server manages a distribution log, which includes content IDs of distributed content, identifiers of user terminals that are distribution destinations, and distribution times, and when a notification occurs of an analysis request, which includes a content ID from the analysis terminal, analysis is performed on a change in a user terminal behavior at the time the content having the content ID was distributed, based on the thus managed action log and distribution log.

Additionally, in a mobile marketing server according to the present invention, distribution of content is performed in accordance with distribution rules. These distribution rules generally have user attributes and user behaviors coded as distribution conditions, so that information is distributed to a user terminal of a user, which matches a distribution rule. The rules therefore reflect the intent of the mobile marketer.

In addition, a mobile marketing server according to the present invention has means for changing a distribution rule by an instruction from an external terminal, for the purpose of performing more effective distribution, base on an examination of the distribution effect by the mobile marketer.

### BRIEF DESCRIPTION OF THE DRAWINGS

FIG. 1 is a block diagram showing an example of the configuration of a first embodiment of the present invention.

FIG. 2 is a block diagram showing an example of the configuration of a user terminal 101-j.

FIG. 3 is a drawing showing an example of an action log, which is stored in an action log database 202.

FIG. 4 is a drawing showing an example of information recorded in a user attribute database 203.

FIG. 5 is a drawing showing an example of the assignment of the meanings of “men's wear department”, “women's wear department”, and “men's shoe department” to rectangular solids defined by two points, a starting point and an ending point, using a three-dimensional coordinate system.

FIG. 6 is a drawing showing an example of a distribution rule recorded in a distribution rule database 204.

FIG. 7 is a drawing showing an example of the correspondences between content IDs and actual content.

FIG. 8 is a drawing showing an example of a distribution log recorded in a distribution log database 207.

FIG. 9 is a block diagram showing an example of the configuration of an analysis terminal 301.

FIG. 10 is a flowchart showing an example of processing for push-type distribution of content from a mobile marketing server 201 to a user terminal.

FIG. 11 is a flowchart showing an example of processing for pull-type distribution of content from a mobile marketing server 201 to a user terminal.

FIG. 12 is a flowchart showing an example of processing when analysis is performed.

FIG. 13 is a drawing showing an example of an analysis of a change in a user distribution condition before and after content distribution, separated by gender.

FIG. 14 is a block diagram showing an example of the configuration of a second embodiment of the present invention.

FIG. 15 is a block diagram showing an example of the configuration of a third, a fourth, and a fifth embodiment of the present invention.

FIG. 16 is a flowchart showing an example of the processing for setting a set of distribution rules and distributed content into a mobile marketing server 201, acquiring the effect thereof, and tuning the distribution rules, performed by an information provider using an analysis terminal 301 in the third embodiment of the present invention.

FIG. 17 is a flowchart showing an example of the processing for setting a set of distribution rules and distributed content into a mobile marketing server 201, acquiring the effect thereof, and tuning the distribution rules, performed by an information provider using an analysis terminal 301 in the fourth and fifth embodiments of the present invention.

### DETAILED DESCRIPTION OF THE PREFERRED EMBODIMENTS

Embodiments of the present invention are described in detail below, with reference made to relevant accompanying drawings.

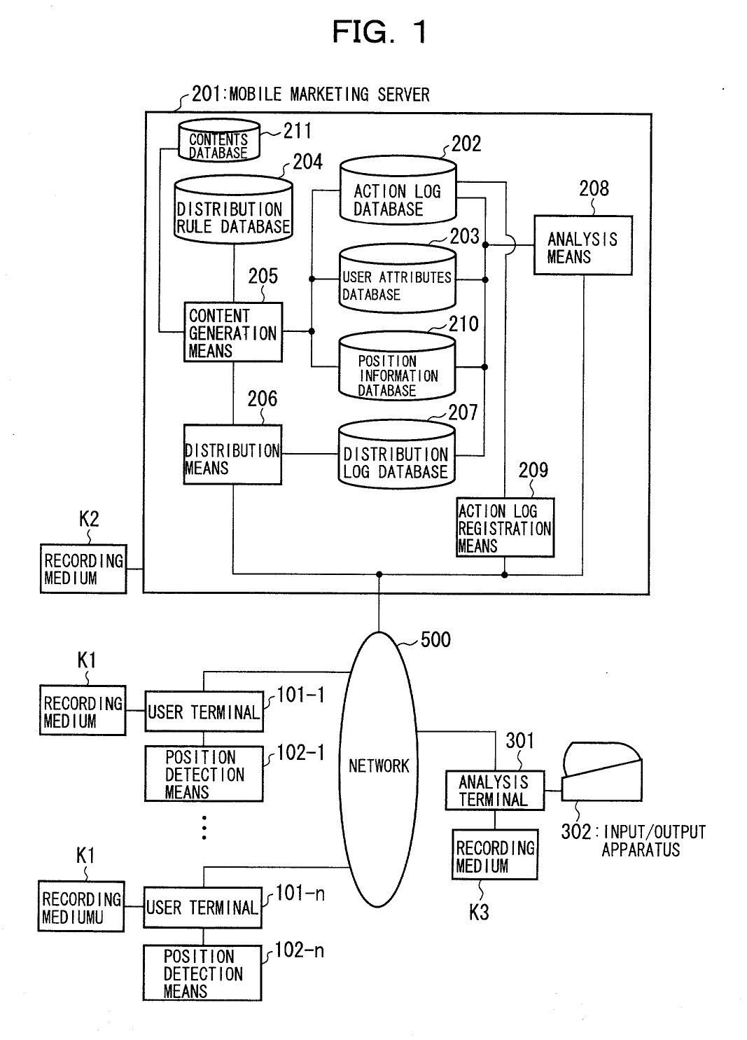

FIG. 1 is a block diagram showing an example of the configuration of a first embodiment of a mobile marketing system according to the present invention. Referring to FIG. 1, this embodiment has a plurality of user terminals 101-1 through 101-n, to which are connected position detection means 102-1 through 102-n, a mobile marketing server 201, an analysis terminal 301, and a network 500, such as the Internet or a local area network (LAN), via which the above elements are mutually connected.

The user terminals 101-1 through 101-n are, for example, PDAs (personal digital assistants) which the use r can carry, or browser phones or the like, which have a network connection function.

The position detection means 102-1 through 102-n are, for example, GPS (Global Positioning System) receivers, or terminal devices of special local position acquiring systems (local positioning systems), which detect the current position of the user terminals 101-1 through 101-n using a coordination system including such as three-dimensional coordinates, latitude and longitude, or polar coordinates.

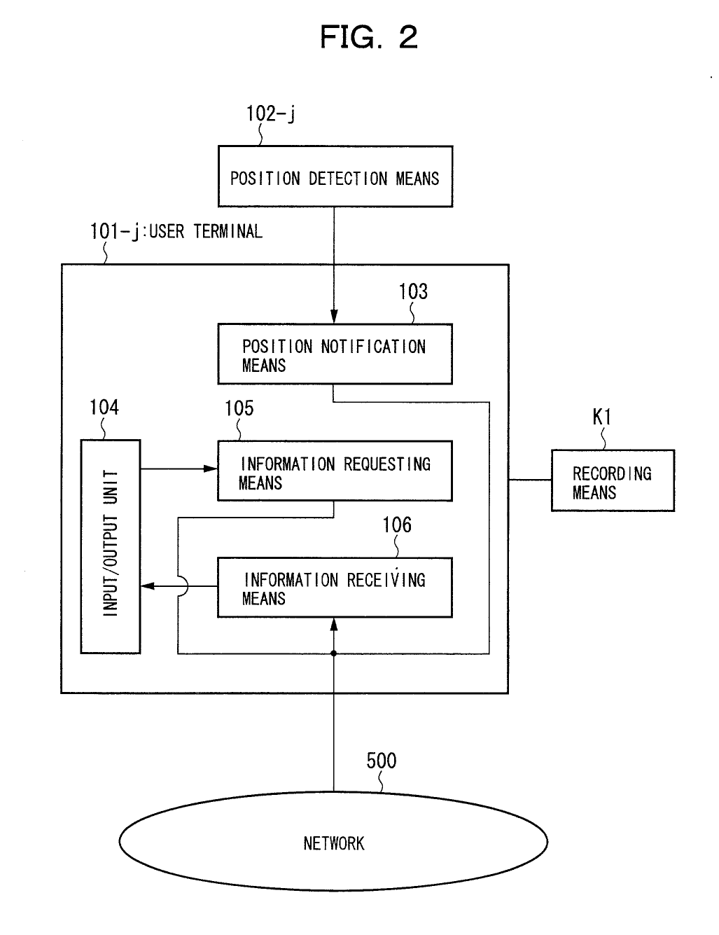

FIG. 2 is a block diagram showing an example of the configuration of a user terminal 101-j (where 1≦j≦n). As illustrated in this drawing, the user terminal 101-j has a position notification means 103, an input/output section 104, an information requesting means 105, an information receiving means 106, and a recording medium K1.

The position notification means 103 has a function of notifying the mobile marketing server 201, via the network 500, of the positional information of the user terminal 101-j detected by the position detecting means 102-j.

The input/output section 104 is formed by an input section (not shown in the drawing), such as a ten-key pad operated by a user, and a display unit (not shown in the drawing), such as a LCD or the like.

The information requesting means 105 has a function of notifying the mobile marketing server 201 of an information request.

The information receiving means 106 has a function of receiving content sent from the mobile marketing server 201 and displaying them on the display unit of the input/output unit 104.

The recording medium K1 is a recording medium such as a disc or semiconductor memory or the like, on which is recorded a program for the purpose of causing the user terminal 101-j formed by a computer to function as part of a mobile marketing system. This program is read by the user terminal 101-j, and controls the operation thereof, so as to implement the position notification means 103, the information requesting means 105, and the information receiving means 106 at the user terminal 101-j.

The mobile marketing system 201 is formed by an action log database 202, a user attributes database 203, a distribution rule database 204, a content generation means 205, a distribution means 206, a distribution log database 207, an analysis means 208, an action log registration means 209, and a position information database 210.

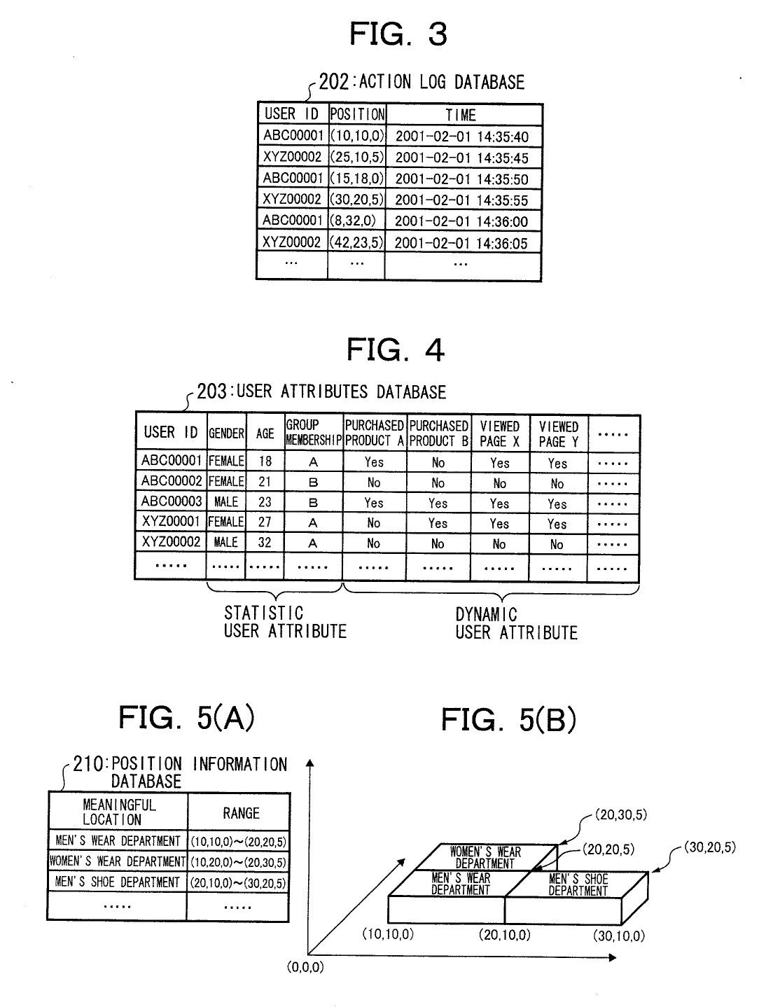

The action log registration means 209 has a function of registering into the action log database 202 an action log, which includes a positional information that notification of which is made of from the user terminal 101-j, an identifier (referred to as a user ID in this embodiment) for the purpose of identifying the user terminal that is the source of the notification, and a position detection time. FIG. 3 shows an example of the contents of the action log database 202.

The user attributes database 203 has registered into it user attributes of users of each of the user terminals 101-1 through 101-n. FIG. 4 shows an example of the contents of the user attributes database 203. In this example, static user attributes, such as gender, age, group membership and the like, and dynamic user attributes, such as information indicating whether or not the users have purchased a given product, and information indicating whether or not the users have viewed certain content, are registered with correspondence to the user IDs of the users of the user terminals 101-n through 101-n.

The position information database 210 has registered in it an actual spatial range defined in terms of a coordinate system, and the relationship of that space to a meaningful location. FIG. 5 (A) shows an example of the contents of the positional information database 210.

The term “meaningful location” used herein refers to some sort of spatial area such as “men's wear department” or “area around Shibuya Station.”

FIG. 5 (A) shows the meaningful locations of the three rectangular solid spaces shown in FIG. 5 (B) as “men's wear department”, “women's wear department”, and “men's shoe department”. In the example of FIG. 5, the spatial ranges are defined as the coordinate values of two vertices of the solid rectangular figures (the vertex having the minimum X, Y, and Z coordinate values, and the vertex having the maximum X, Y, and Z coordinate values).

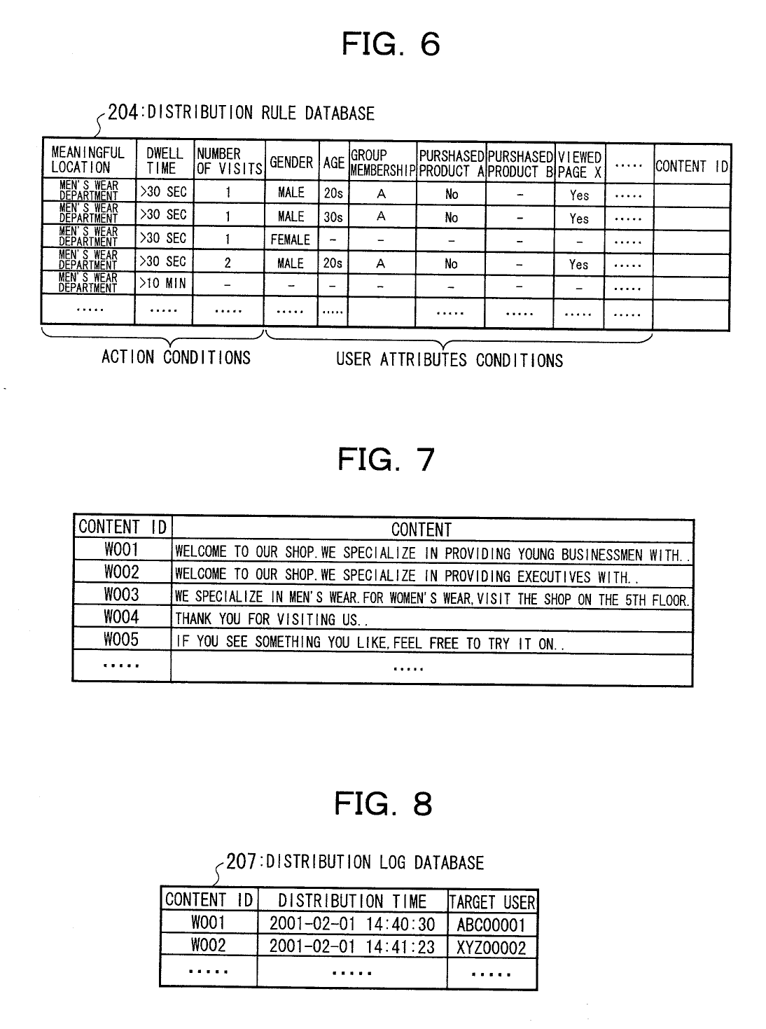

The distribution rule database 204 has registered in it a plurality of distribution rules for the purpose of distributing content suitable to a behavior and user attributes of a user terminal. Each distribution rule includes a user terminal action condition, a user attribute condition, and a content ID of content to be distributed. FIG. 6 shows an example of the contents of the distribution rule database 204. In the example of FIG. 6, the action conditions include corresponding meaningful locations, dwelling times, and number of visits, and the user attribute conditions include gender, age, group membership, product purchase information, and content browsing information.

The content generation means 205 has a function that sets the user terminal 101-j as the processing target user terminal if the action log and user attributes of the user terminal 101-j that is the source of the position notification match a distribution rule registered in the distribution rule database 204, and a function that generates content to be distributed to the processing target user terminal 101-j based on the content database 211, using the content ID of the above-noted rules that matched as a key. FIG. 7 shows an example of the relationship of correspondence between content IDs and actual content. As shown in this drawing, in the case in which text data is indicated and the case in which a URL is indicated, the content generation means 205 acquires the actual data of the content, via the network 500.

The distribution means 206 has a function that distributes content generated by the content generation means 205 to the user terminal 101-j via the network 500, and a function that registers information with regard to what content was distribute to whom and when into the distribution log database 207. FIG. 8 shows an example of the contents of the distribution log database 207. In the example of FIG. 8, a distribution log, which includes the content ID of the distributed content, the time the content was distributed, and an identifier that identifies the user terminal that was the distribution destination (the user ID in this example) is registered in the distribution log database 207.

The analysis means 208 has a function that accesses the action log database 202, the user attributes database 203, the distribution log database 207, and the position information database 210, and performs data analysis processing in accordance with the analysis items and analysis conditions that are part of an analysis request that is sent from the analysis terminal 301, and sends the analysis results to the analysis terminal 301.

The analysis terminal 301 is a data processing apparatus such as a personal computer. The analysis terminal 301 has a function that accesses analysis means 208 of the mobile marketing server 201 via the network 500, and makes notification of an analysis request, including items and conditions for analysis, and a function that receives the results of an analysis sent from the mobile marketing server 201 and displays same.

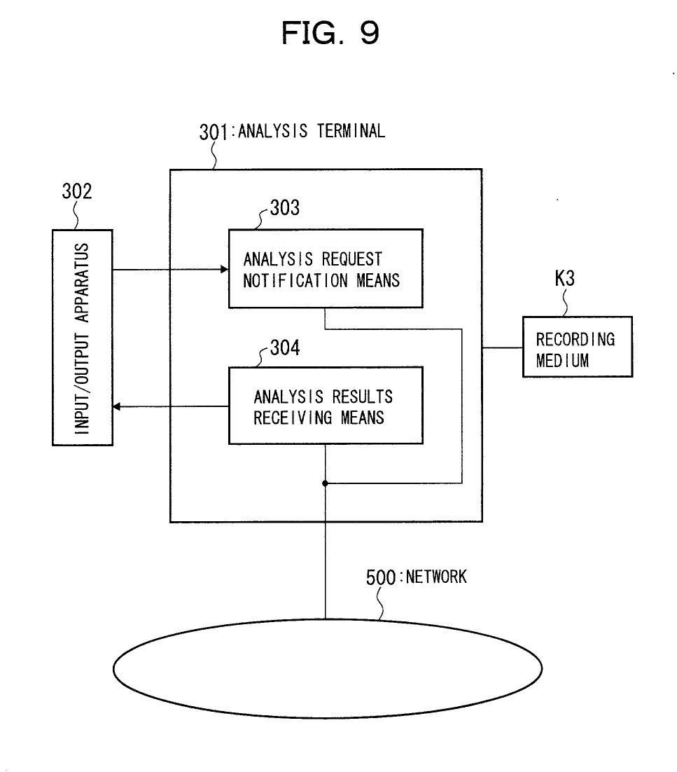

FIG. 9 is a block diagram showing an example of the configuration of the analysis terminal 301, which has an input/output apparatus 302, an analysis request notification means 303, an analysis results receiving means 304, and a recording medium K3.

The input/output apparatus 302 is made up of an input section (not shown in the drawing) such as a keyboard or the like, and a display unit (not shown in the drawing) such as a LCD or the like. The analysis request notification means 303 has a function that makes a notification of an analysis request, which includes and analysis items and analysis conditions, to the analysis means 208 via the network 500. The analysis results receiving means 304 has a function that receives analysis results sent from the mobile marketing server 201 and displays the results on the display unit of the input/output apparatus 302.

The operation of this embodiment of the present invention is described below, with reference made to a flowchart.

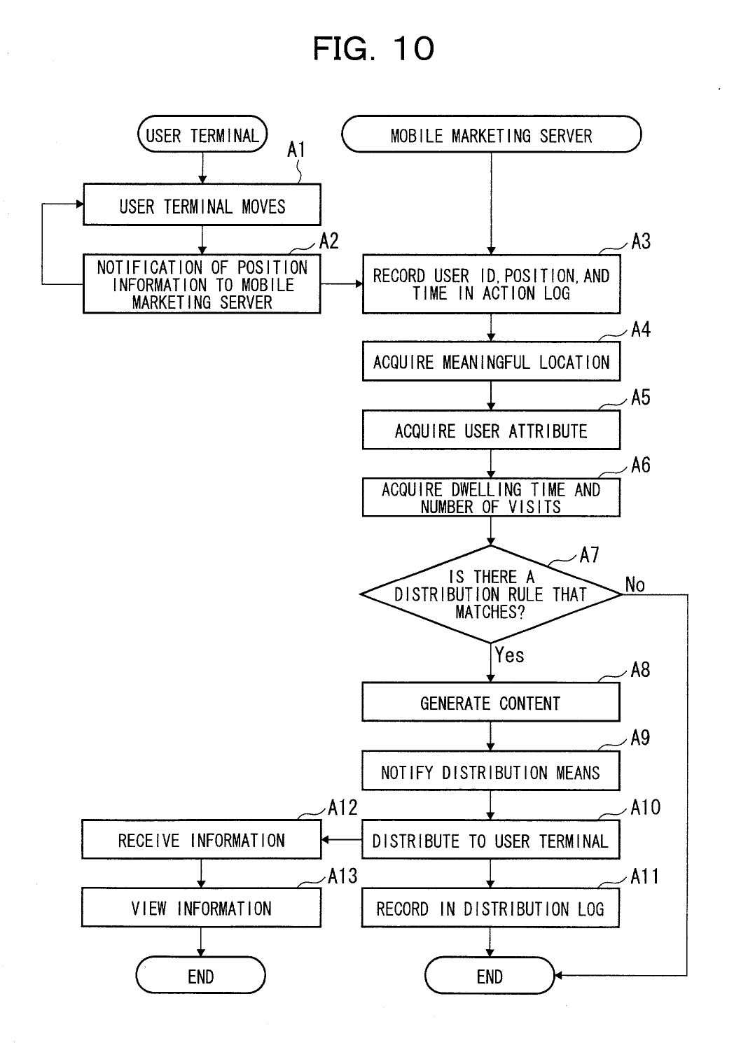

FIG. 10 is a flowchart showing an example of processing when push-type content distribution is performed, this showing the sequence of processing performed from the time at which a user terminal 101-j notifies the mobile marketing server 201 of its terminal position until the time at which the mobile marketing server 201 distributes content to the user terminal 101-j.

In FIG. 10 the user terminal 101-j periodically captures the detection results of the position detection means 102-j and, in the case in which the detection results are different from the previously captured detection results (that is, when there has been movement of the user terminal 101-j), the captured detection results at this time are notified to the mobile marketing server 201 via the network 500 as the present position of the terminal 101-j (steps A1 and A2).

Upon being notified of the positional information of the terminal 101-j, the action log registration means 209 in the mobile marketing server 201 registers the notified positional information, the user ID that species the user terminal 101-j that was the source of the notification and the current time into the action log database 202 (step A3).

Next, the content generation means 205 acquires a meaningful location in a space within which the user terminal 101-j currently exist (step A4), based on the positional information sent from the user terminal 101-j and the contents of the position information database 210. The content generation means 205 further acquires the user attributes of the user of the user terminal 101-j, based on the contents of the user attributes database 203 and, based on the contents of the action log database 202, determines the number of times the user terminal 101-j has visited and the amount of time the user terminal 101-j has stayed at the meaningful location obtained at the step of A4, based on the contents of the action log database 202 (steps A5 and A6).

After the above, the content generation means 205 performs a search of the distribution rule database 204 for a distribution rule that satisfies all of the following conditions (step A7).

a. Meaningful location in the action condition matches the meaningful location at which the user terminal 101-j currently exists, which was acquired at step A4.

b. The amount of dwelling time and number of visits in the action condition matches the dwelling time and number of visits determined at step A6.

c. The user attribute conditions matches the user attributes acquired at step A5.

In the case of not being able to find a distribution rule that satisfies all of the conditions a to c (i.e. a No result at step A7), the processing is terminated. If, however, it was possible to find a distribution rule satisfying all of the conditions a to c (Yes result at step S7), content is generated based on the content ID included in the found distribution rule (step A8). The generation of content can be easily done using a table that sets up a correspondence between content IDs and actual content, such as shown in FIG. 7.

When the content is generated, the generated content and information indicating the user terminal 101-j, which is the distribution destination thereof, are passed to the distribution means 206 (step A9). By doing this, the distribution means 206 distributes the content to the user terminal 101-j via the network 500, and registers a distribution log, which includes the content ID of the distributed content, the user ID of the user terminal 101-j that was the distribution destination, and the time of distribution, into the distribution log database 207 (steps A10 and A11).

The content distributed from the distribution means 206 is received by the information receiving means 106 of the user terminal 101-j and is displayed on the display unit of the input/output unit 104 (steps A12 and A13). By doing this, the user of the user terminal 101-j can browse content that is suitable to his or her behaviors and user attributes. This completes the operation of a push-type content distribution.

Although not described above, if there is content with regard to which it is desired to restrict the number of distributions to the same user terminal, the following can be done, for example. First, a table of number of distributions upper limit values in which an upper limit of number for distributing each one of the content, linked to the content IDs (not shown), is prepared.

At step A9, when passing the content to the distribution means 206, the content generation means 205 also passes the content ID to the distribution means 206. At step A10 when the distribution means 206 distributes the content to the user terminal 101-j, it acquires the upper limit number of times for distribution of the above-noted content from number of distributions upper limit value table and accesses the distribution log database 207 to determine the number of times that content has already been distributed to the user terminal 101-j up to date. If the number of times distributed does not exceed the upper limit value, the content is distributed to the user terminal 101-j, but if the number of times distributed would exceed the upper limit value at this time, the content is not distributed. By doing this, it is possible to control the number of times for the same content to be distributed to one and the same user terminal.

In the above operational description, the processing target user terminal for which a content suitable to the behavior and user attribute should be generated, was a user terminal that was not only the source of a position notification, but also satisfied one of the distribution rule registered in the distribution rule database 204. However, it is alternately possible to determine the processing target user terminal by performing the following processing each given period of time.

Consider the 1st distribution rule stored in the distribution rule database 204. Then access the action log database 202, the user attributes database 203 and the position information data base 210 to search for a user terminal that matches the 1st distribution rule, and set this terminal as the processing target user terminal. Then content to be distributed to the processing target user terminal is generated, based on the content ID in the 1st distribution rule. Next, the 2^{nd}distribution rule is considered, and the same type of processing is performed. Thereafter, this processing is performed until the last distribution rule is processed.

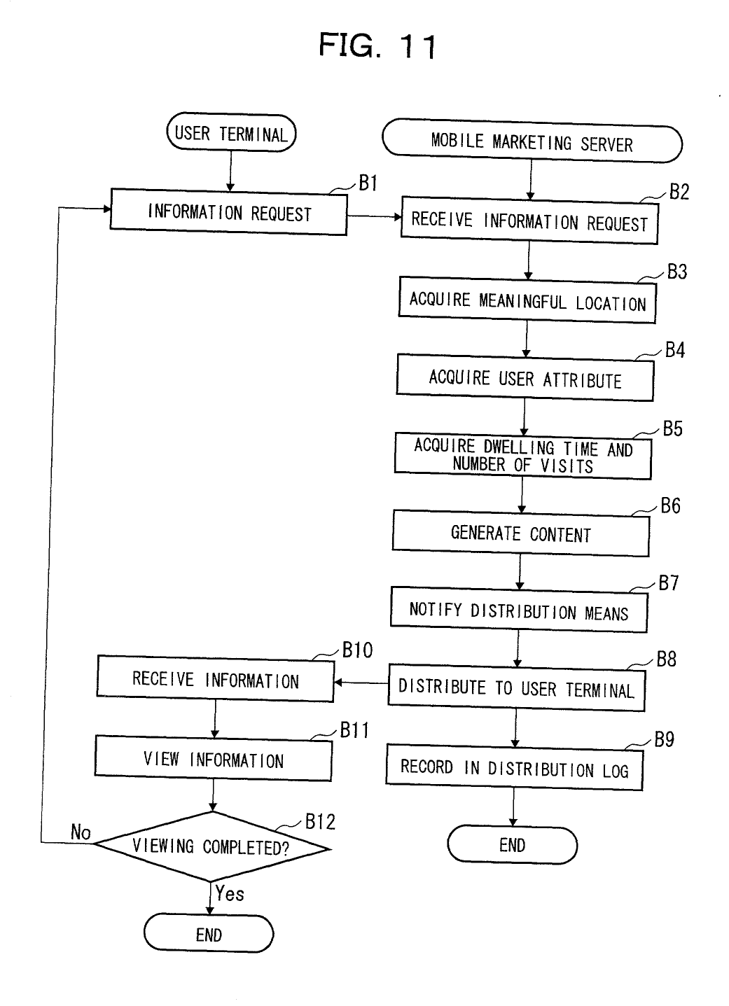

The operation of performing a pull-type content distribution to the user terminal 101-j from the mobile marketing server 201 is described below, with reference made to the flowchart of FIG. 11.

When the user of the user terminal 101-j wishes to request content from the mobile marketing server 201, the he or she operates the input/output unit 104 to cause the information requesting means 105 to operate. By doing this, the information requesting means 105 notifies the mobile marketing server 201, via the network 500, of an information request, which includes an identifier (the user ID in this embodiment) for identifying itself and its position (step B1).

Upon receiving the information request from the user terminal 101-j (step B2), the content generation means 205 of the mobile marketing server 201 acquires a meaningful location in the space in which the user terminal 101-j exists, based on the position included in the request information and the contents of the position information database 210 (step B3), and also acquires the user attributes of the user terminal 101-j, based on the contents of the user attributes database 203 (step B4).

After this is done, the content generation means 205 accesses the action log database 202 to determine the number of times the user terminal 101-j has visited the meaningful location determined at step B3 and the amount of time spent there (step B5).

After the above, the content generation means 205, based on the information acquired at steps B3 to B5 and the contents of the distribution log database 207, generates content to be distributed to the user terminal 101-j, and passes the generated content and information indicating the user terminal 101-j to the distribution means 206 (steps B6 and B7). A more detailed description of the processing at steps B6 and B7 is given below.

First, a search is made of the distribution rule database 204 to find a distribution rule matching the meaningful location, the user attributes, the dwelling time, and the number of visits determined at steps B3 to B5. In the case in which such a distribution rule was found, content is generated based on the content ID in the distribution rule, and the generated content and distribution destination are passed to the distribution means 206. If there was no rule that could be found, however, pre-established fixed content and the distribution destination are passed to the distribution means 206. It is further possible to pre-establish fixed content for each meaningful location at which a user terminal making a request could exist, and to pass to the distribution means 206, content thereof corresponding to the meaningful location acquired at step B3. This completes the detailed description of the processing of steps B6 and B7.

When the content and information indicating the distribution destination user terminal 101-j are passed to the distribution means 206 from the content generation means 205, the distribution means 206 distributes the above-noted content to the user terminal 101-j via the network 500, and registers the distribution log into the distribution log database 207 (steps B8 and B9).

Upon receiving the content distributed at step B8 (step B10), the information receiving means 106 within the user terminal 101-j displays same on the display unit of the input/output unit 104, so that user can browse the content (step B11). If the user makes another information request (No result at step B12), return is made to step B1 and this series of processing steps is repeated. If there is no further request (Yes result at step B12) processing is terminated. This completes the operation of making a pull-type content distribution.

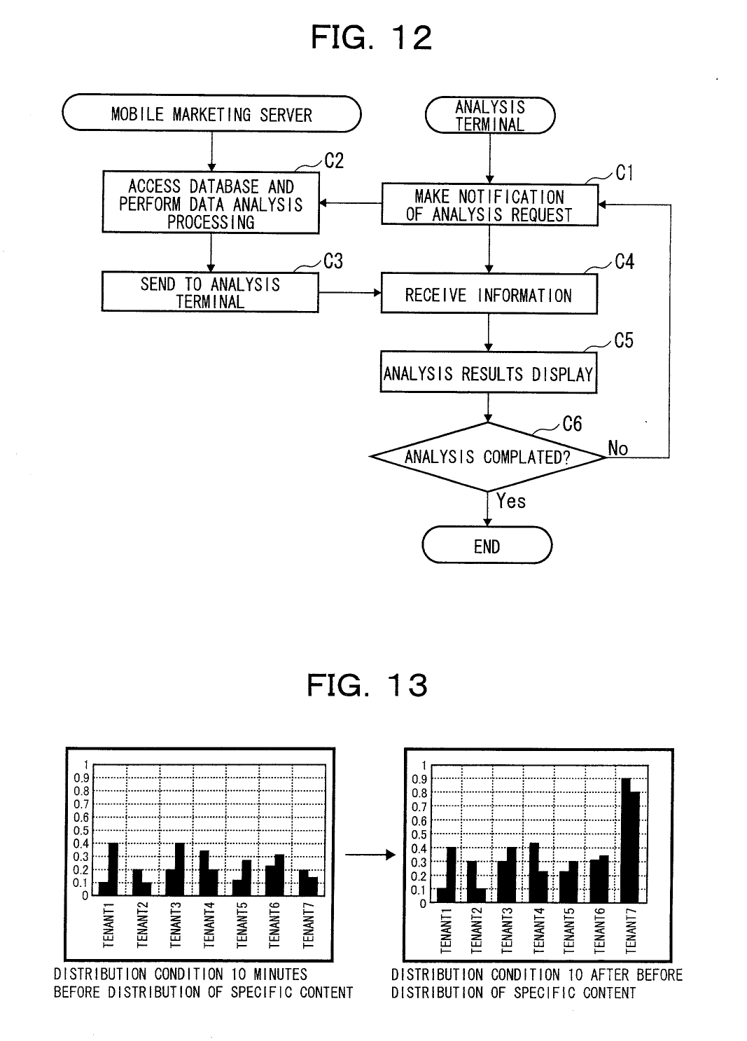

The operation of performing analysis processing is described below, with reference made to the flowchart of FIG. 12.

When a user of an analysis terminal 301 makes a request for analysis to the mobile marketing server 201, the analysis items and analysis conditions are input from the input/output apparatus 302. By doing this, analysis request notification means 303 of the analysis terminal 301 notifies the mobile marketing server 201, via the network 500, of the input analysis items and analysis conditions (step C1). The analysis items referred to herein is, for example, a user distribution condition, an average dwell time, or a visiting ratio, and the analysis conditions as used herein refers to such conditions as the analysis target time (and time period), location, user attributes, action attributes, and content ID or the like. The analysis conditions are different, depending upon the analysis items.

When notification is made of the analysis request, the analysis means 208 at the mobile marketing server 201 accesses the required databases of the action log database 202, the user attributes database 203, the distribution log database 207, and the position information database 210 in order to perform processing of the request, and performs data analysis processing in accordance with the contents of the analysis request (step C2). After this is done, the analysis means 208 sends the analysis results to the analysis terminal 301 (step C3).

Upon receiving the analysis results (step C4), the analysis results receiving means 304 within the analysis terminal 301 displays these on the display unit of the input/output apparatus 302 (step C5).

If there is a subsequent analysis to be performed with changes to the analysis items and conditions, the analysis items and analysis conditions are input once again from the input/output apparatus 302. By doing this, judgment result at step C6 becomes No, whereupon the sequence of processing steps from step C1 is performed again. If the analysis is to be ended, however, the user indicates the end of analysis at the input/output apparatus 302, thereby causing the result at the judgment step C6 to be Yes, at which point the processing is terminated.

The operation is further described below, taking a specific example.

In the case in which the user terminal distribution condition at a given time t1 is to be checked, at step C1 an analysis request including “distribution condition” as an analysis item and “time t1” as an analysis condition is sent to the mobile marketing server 201. Upon being notified of the above-noted analysis request, the analysis means 208 performs the following processing at step C2.

First, the action log database 202 is searched to determine the position of each user terminal at the time t1. Then, the analysis means 208 acquires the spatial range corresponding to the 1st meaningful location (a men's wear department in the example of FIG. 5), and determines the number of user terminals existing within that spatial range, based on the already determined positions of each user terminal. After this is done, the analysis means 208 determines the number of user terminals existing at the 2nd meaningful location. Thereafter, this processing is repeated up until the last meaningful location. By doing this, the number of user terminals existing at each meaningful location at the time t1 (the user terminal distribution condition at time t1) can be determined.

Alternatively, consider the case in which it is desired to analysis the distribution conditions before and after user terminals received content having the content ID W001. In this case, an analysis request including “distribution condition” as an analysis item and “W001” as an analysis condition is sent to the mobile marketing server 201. Upon being notified of the above-noted analysis request, the analysis means 208 first accesses the distribution log database 207 to acquire all combinations of terminals that received the content having the content ID W001 and the times at which the content was distributes. Then, focusing on the 1st combination of the combinations of user terminals and distribution times, the meaningful locations at which the above-noted distribution target user terminals existed at prescribed time before and a prescribed time after the above-noted distribution time are determined, based on the contents of the action log database 202 and the position information database 210. More specifically, the positions of the user terminals at the prescribed amount of time before and the prescribed amount of time after the above-noted distribution times are determined by accessing the action log database 202, and the meaningful locations at the determined positions are determined by accessing the position information database 210. Next, the same type of processing is performed for the 2nd combination. This processing is repeated until all combinations have been processed. By doing this, it is possible to perform a collective analysis of user terminal distribution conditions before and after a distribution time of content, even if the times that the content was distributed to the user differ.

When performing the above-described processing, by specifying an item (gender), age, group membership, and in particular a track record of product purchases stored in the user attributes database 203, it is possible to perform a comparative analysis by gender, or to perform a comparative analysis that combines attributes, for example, a comparison between women in their 20s and men in their 30s. By doing this, it is possible not only to analyze the influence of distributed content on user terminal behaviors, but also to analyze in depth the difference in this influence based on the attributes of a user terminal, thereby providing and analyzing marketing information.

FIG. 13 shows an example in which an analysis is performed of the change in the user terminal distribution condition before and after a specific content is distributed, distinguishing men and women.

In this embodiment, as noted above, because the distribution mechanism and the analysis mechanism are combined, with databases created for user attributes, action logs, and distribution logs and stored within the mobile marketing server 201 for access at any time, the effect achieved is that of being able to use any of the position information, the user attributes, and the action log information as distribution condition parameter when distributing content.

Additionally, because it is possible from the distribution log to determine when and to whom particular content was distributed, and from the action log to determine the actions before and after that time, thereby achieving the effect of being able to compare and analyze the action conditions before and after a specific content is distributed thereto at differing times.

Furthermore, in the present embodiment the configuration is one in which the position detection means 102-j is linked to the user terminal 101-j, the position detected by the position detection means 102-j being notified to the mobile marketing server 201 via the user terminal 101-j. It will be understood that it is sufficient for the mobile marketing server to be notified by some means of the position, and it is possible that the position detection means 102-j and the user terminal 101-j be mutually independent.

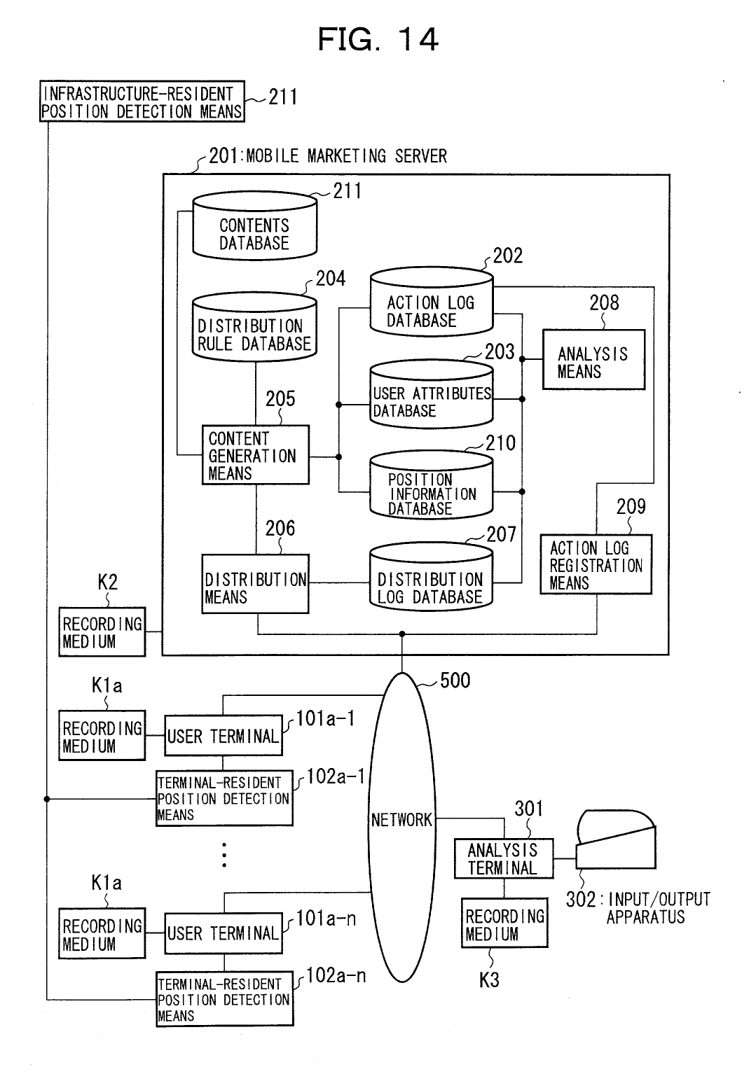

FIG. 14 is a block diagram showing an example of the configuration of a second embodiment of the present invention. In this embodiment, the positions of the user terminals 101a-j are detected by the combination of terminal-resident position detection means 102a-j, each of which transmits its characteristic identifier, and an infrastructure-resident position detection means 211, which receives with a receiver the identifiers generated by the terminal-resident position detection means 102a-j and determines the positions thereof (positions of the user terminals 101a-j) based on the results of this reception.

The terminal-resident position detection means 101a-j are mobile telephones or dedicated local position acquiring systems (local positioning systems), and the infrastructure-resident position detection means 211 is an infrastructure-based apparatus (tag reader or ID reader and the like) of a base station or local positioning system. If a radio tag that transmits the characteristic ID is used as the terminal-resident position detection means 102a-j, for example, a reading apparatus that reads the radio tag can be used as the infrastructure-resident position detection means 211. In place of the radio tag, it is possible to use a portable telephone such as used in the PHS (Japan's Personal Handyphone System) or the like, and in place of the reading apparatus it is possible to use a base station, the same type of effect being achieved.

Additionally, in this embodiment because the user terminals 101a-j are formed by combinations of terminal-resident position detection means 102a-j and infrastructure-resident position detection means 211, by which the position of the user terminals 101a-j are detected, there is no necessity for a position notification means 103 (refer to FIG. 2) to notify the mobile marketing server 201 of the position. A program recorded on the recording medium K1a can be the program recorded on the recording medium K1, except with the part that implements the position notification means 103 removed.

A third embodiment of the present invention is described below. In this embodiment, a mobile marketer acquires the effect of distributing information linked to a location, using a mobile marketing server, and tunes the distribution rules for the purpose of improving the effectiveness of distribution, based on the acquired data.

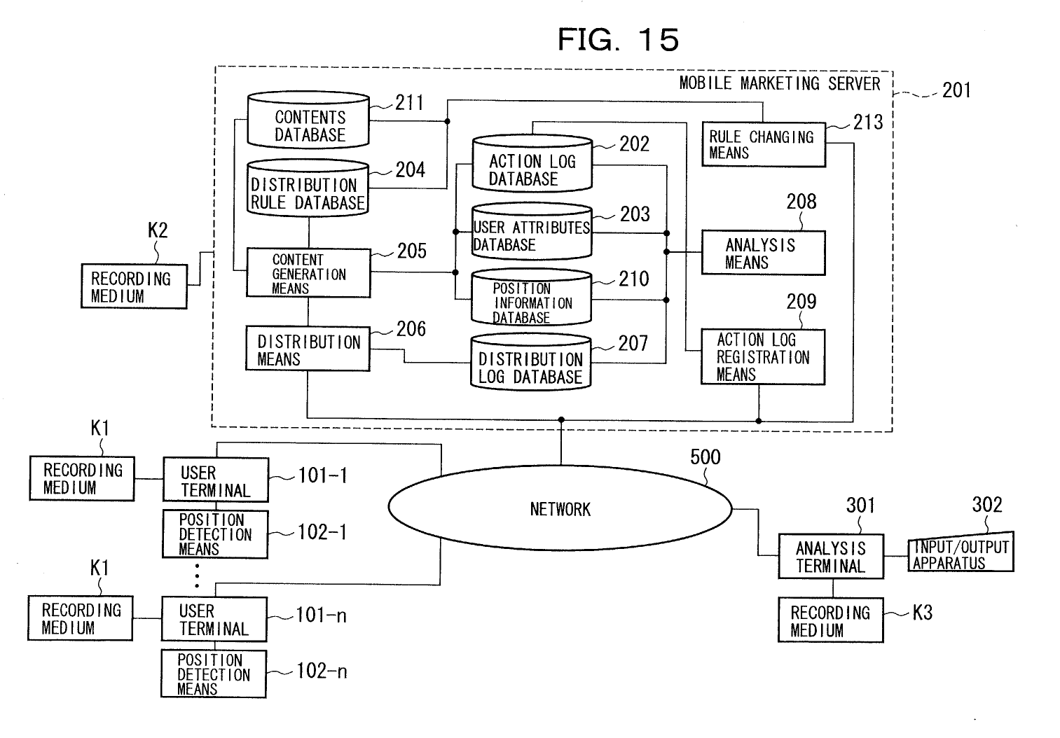

FIG. 15 is a block diagram showing an example of the configuration of a server in the third embodiment of the present invention.

This configuration is different from the configuration as shown in FIG. 1, from the point of view of existing the rule changing means 213.

In this configuration the rule changing means 213 has a function that performs registration of a new rule, deletion of a rule, changing of a distribution condition, and changing of the actual content with respect to the distribution rule database 204, and the rule changing means 213 receives an instruction from an external terminal connected to a network and executes processing.

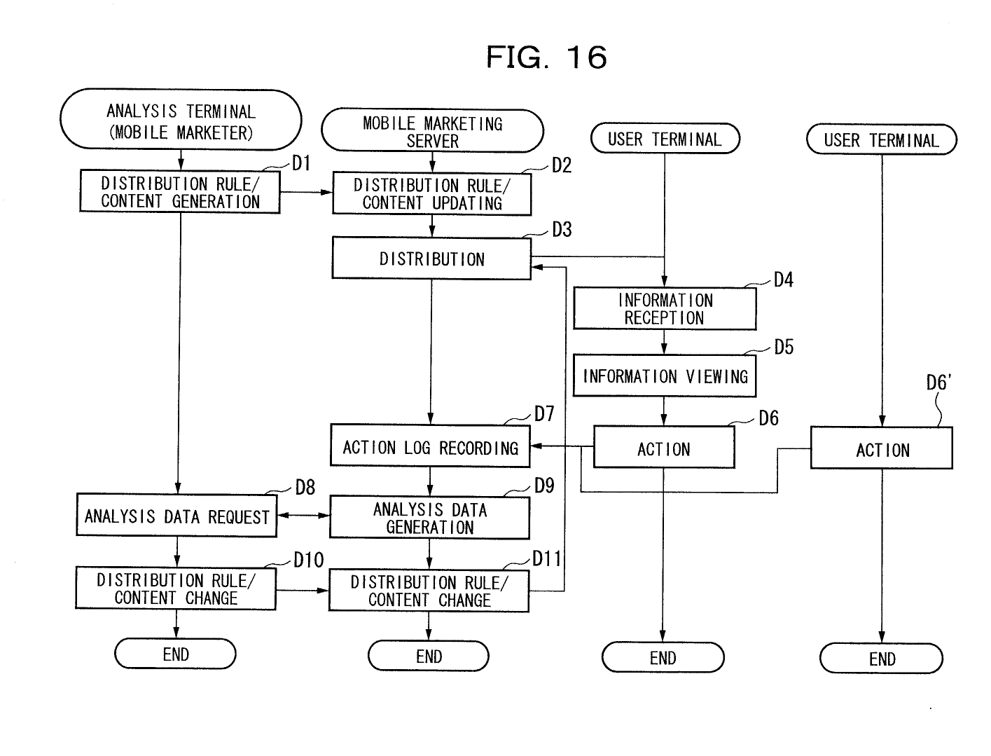

FIG. 16 is a flowchart showing the flow of processing in the third embodiment, this flowchart showing the sequence of processing whereby the mobile marketer uses an analysis terminal 301 to set a set of distribution rules and content to be distributed into the mobile marketing server 201, and then acquires the effect thereof and tunes the distribution rules.

A pre-requisite condition is that the users on the system are divided into two groups. In this case, it shall be assumed that there is no bias between the groups in terms of gender or age. An ID of a group to which a user belongs is set into the user attribute database 207.

In this embodiment, the two groups are called group 1 and group 2.

First, the mobile marketer generates rules for distribution of content associated with a location to a user who has arrived at that location. With regard to a given location, in the case in which a rule is generated so as to distribute to a user of group 1, there is no distribution to a user of group 2. Similarly, in the case in which a rule is generated so as to distribute to a user of group 2 in different places, respectively, there is no distribution to a user of group 1. The analysis terminal 301 is used to register these distribution rules and the contents associated with locations for distributions into a mobile marketing server (step D1).

At the mobile marketing server, the rule changing means 213 registers the stored distribution rules and content into the distribution rule database 204 and the content database 211 (step D2). The distribution is then performed in accordance with the distribution rules (step D3).

When the user visits a particular location, if the user belongs to a group to which a distribution rule under which a content associated with that location can be distributed, is set, the user terminal receives the content (step D4).

After viewing the received content, the user remains for a while and then leaves that location (steps D5 and D6).

If the user belonged to a group to which a distribution rule for distribution of content associated with the above-noted location is not set, the user cannot receive the content and remains there for a while and then leaves that location (step D6′).

The action log registration means 209 of the mobile marketing server records the time of content distribution to the user, and the visiting and leaving time for each location into the action log database as an action log (step D7).

Some time after performing distribution the mobile marketer request analysis data via the analysis terminal (step D8). At this point, the average dwelling time for each group at each location is requested as the analysis data.

The analysis means 208 of the mobile marketing server uses the data stored in the action log database 202 to generate the analysis data (average dwell time for each group) requested at step D8 (step D9).

The mobile marketer changes the distribution rule set from the analysis terminal based on the thus obtained analysis data (step D10). If the average dwelling time of a group to which distribution of content was made at a given location is greater than the average dwelling time of the other group, the judgment is made that there was a large effect by the distribution of content, the rule being changed so that distribution is made to all users. If, however, the average dwell time of a group to which content is distributed in association with a particular location is almost the same as or shorter than that of the other group, it is taken that there is no effect attributed to content distribution, the distribution rule being deleted, and the mobile marketer study a way to improve the distributed content.

At step D8, when the average dwell time is requested by gender as the analysis data, it is possible to obtain content distribution effectiveness by gender. For example, if the average dwell time of females in a group to which content is distributed in association with a particular location is longer than the average dwell time of females of a group that was not the target of content distribution, it can be said that the content distribution has had an effect. Additionally, in the case in which no effect is seen in distributing content to males, a distribution rule for content associated with the location can be changed so as to distribute content only to females and the same type of processing can be performed with respect to age as well.

In response to the above-noted processing, at the mobile marketing server the distribution rules and content are changed. Thus, the analysis results are fed back so that distribution is subsequently performed in accordance with updated distribution rules (step D3). The above-described processing enables tuning of the distribution rules in order to lengthen the time that a user spends at a given location, thereby enabling the provision of a more effective mobile marketing service.

A fourth embodiment of the present invention is described below. In this embodiment, similar to the case of the third embodiment, a mobile marketer uses a mobile marketing server to acquire the effectiveness of distributing content associated with a given location, and tunes the distribution rules based on the thus acquired data for the purpose of improving the effectiveness of the content distribution.

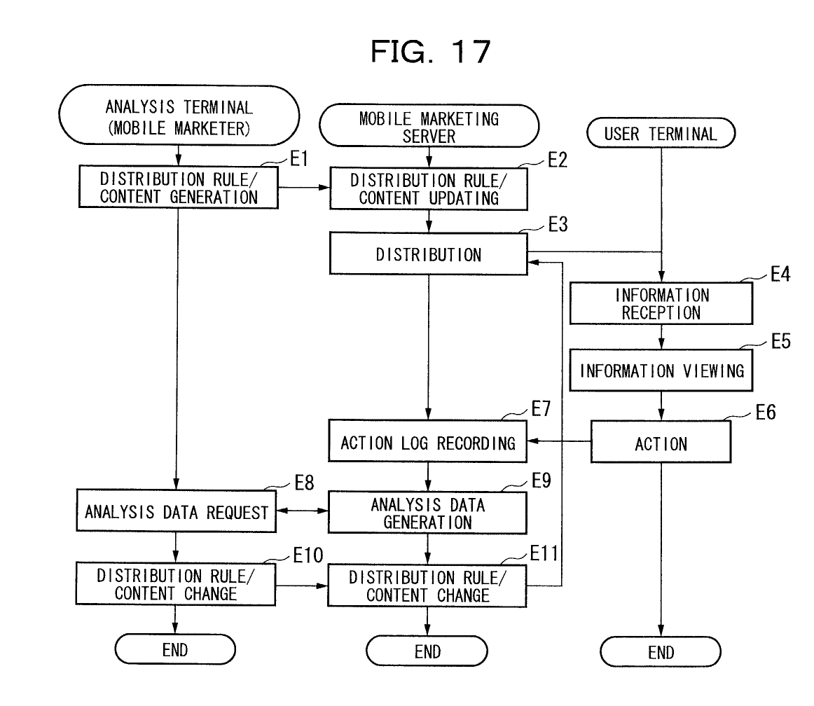

In this embodiment, the differences in dwell times at a store depending upon age are used to tune the distribution rules so as to guide a class of users tending to spend more time in a store. The processing flow is illustrated in the flowchart of FIG. 17.

First, the mobile marketer uses the analysis terminal to generate a distribution rules and distributing content so that as many users as possible visit a certain place (step E1). As an example, a game content is made available for a game with the aim of gaining points, information being provided as a hint for a given location, and points being won by going to the location indicated by the hint. This can be done for the purpose of collecting information on even users who would not go to that location unless information were to be provided.

At the mobile marketing server, the rule changing means 212 registers a registered distribution rule into the distribution rule database 204 (step E2). Distribution is then performed based on this distribution rule (step E3).

The user terminal receives the distributed information, and the user views this received information (steps E4 and E5). In this example, the distributed information is information providing a hint about a certain location, and if the user ultimately moves so as to reach the correct location, a point allocation operation or the like is performed as part of the content, followed by leaving that location after some period of time (step E6).

The action log database registration means 209 of the mobile marketing server registers the time of content distribution and the time of visiting each location into the action log database (step E7).

A bit of time after the distribution, the mobile marketer, via the analysis terminal, requests analysis data (step E8). In this case, the values determined by the Equation (1) given below are determined as analysis data for male users, for female users, and for each age group at each one of the locations.

(Number of people dwelling for more than a certain amount of time)/(Number of visitors) (1)

The analysis means 208 of the mobile marketing server generates analysis data indicated by Equation (1) requested at step E8 (step E9).

The mobile marketer changes the distribution rule from the analysis terminal, based on the acquired analysis data (step E10). In this embodiment, data from Equation (1) for each gender and each age group at the respective places are obtained as analysis data. This data can be treated as marketing data indicating the proportion of users that visited the location to get points and dwelled there for some time with some interest in the location to all the visitors who had visited the location to get points. If this value is low overall for all classes of users, it can be said that there are few users who are interested.

In such as case, the mobile marketer considers such counteractions as changing the display or the like so as to build interest in the users. If the value obtained from Equation (1) is high for a particular group of users for a certain place (for example, females or high school students), this means that that location has something that attracts users of that group. The information with regard to what user group is attracted to each location is extremely effective marketing information. In order to improve the effectiveness of distributing information, the distribution rule is changed as follows.

First, the distribution of information which guides users to a location for which the overall value obtained from Equation (1) is low is stopped. With regard to other locations, information is distributed to users having a high value obtained from Equation (1), so as to attract such users to that place and distribution of information to the users having a low value obtained from Equation (1) and which might attract users, is stopped.

Upon receiving a change request from the analysis terminal, the mobile marketing server updates the distribution rule and the content (step E11), and this result is fed back, so that the distribution is performed thereafter with the updated rule (step E3).

As described above, by feeding back analysis results, it is possible to narrow the target of users, making it possible to expect users to dwell longer at a particular location.

A fifth embodiment of the present invention is described next. In this embodiment, similar to the third embodiment, a mobile marketer uses a mobile marketing server to acquire the effectiveness of distributing content associated with a given location, and tunes the distribution rules based on the thus acquired data for the purpose of improving the effectiveness of the content distribution.

In this embodiment, user action data after information distribution classified based on user action attributes at the time of distribution (such as the location of a user and the number of times a user visits a given location) are used as the based for selecting action attributes for which the information distribution effectiveness is high, and the distribution rules are tuned so as to distribute information to users having these action attributes. The flow of processing, similar to the case of the fourth embodiment, is described specifically below, using FIG. 17.

The example described here is one in which the mobile marketer wishes to make a judgment, which is a bast way to which user among the users locating in various places, a certain information should be distributed.

The mobile marketer generates distribution rules and content to be distributed at an analysis terminal. In this case, three types of rules for distributing information attracting users to a certain location on the first floor to users, for example, a rule to distribute such information to users on the first floor (rule 1), a rule to distribute to users on the third floor (rule 2), and a rule to distribute to users on the fifth floor (rule 3) are created.

At the mobile marketing server, the registered distribution rules and content are registered into the distribution rule database 204 by the rule changing means 212 (step E12). Distribution is performed in accordance with these distribution rules (step E3).

The user terminal receives the distributed information, and the user views the information (steps E4 and E5). Because this information is intended to attract users to a certain location, a part of the users will visit the specified location, stay a while and then leave, while there are some users who will not do this (step E6).

The action log registration means 209 of the mobile marketing server records the time of content distribution to the user and the time of visiting and leaving each location by the user as an action log into the action log database (step E7).

After some time has passed following such information distribution, the mobile marketer request analysis data via the analysis terminal (step E8). In this case, the visiting ratio of the users to whom such information had been distributed and being attracted to and visiting the specified location in coincidence with the rules 1, 2, and 3 are calculated by Equation (2) as the analysis data.

(Number of persons visiting the attracting location after distribution)/(Number of persons to whom distribution was done) (2)

The analysis means 208 of the mobile marketing server generates analysis data (data indicated by Equation (2)) as requested at step E8 (step E9).

The mobile marketer changes the distribution rule set from the analysis terminal, based on the thus acquired analysis data (step E10). For example, if the visiting ratio of users coinciding with rule 1 (distribution of information to attract users on the first floor) is higher than the one coinciding with other rules, the rule is changed so that the information attracting users to the first floor location is distributed to users on the first floor.

Upon receiving a request for a change from the analysis terminal, the mobile marketing server updates the distribution rules and content (step E11), and these analysis results are fed back, so that distribution is performed in accordance with the updated rule (step E3).

By feeding back the analysis results in this manner, it is possible to attract a narrowed group of target users, thereby achieving a larger number of visitors to the target location to which users are to be attracted.

The present invention, configured as described above, achieves a number of effects.

A first effect is that of enabling distribution of content suitable to user terminal behavior and user attributes. The present invention is able to do this because the attributes of the user of the user terminal are managed in the mobile marketing server and, when generating the content, generation of content is done with consideration given to these user attributes.

A second effect achieved by the present invention is that of enabling comparative analysis of the actions of users before and after content distribution, even if the time of content distribution to the users differs between individual user terminals. It is able to do this because the mobile marketing server manages a distribution log, which includes IDs of distributed content, identifiers of the user terminals to which content was distributed, and the times of distribution thereto, this distribution log being accessed at the time of analysis so as to detect the action conditions before and after distribution for each user individually, these being integrated to analyze the overall action behaviors.

The third effect achieved by the present invention is that of feeding back analysis results to the distribution rules, thereby enabling an improvement in the effect of information distribution performed by the system. The reason this is possible is the present invention has both a distribution function and an analysis function, whereby the effectiveness of the information distribution is determined and known, and a function for changing the distribution rules, based on that effectiveness.

What is claimed is:

1. A mobile marketing method comprises:
a mobile marketing server, capable of communication with a plurality of mobile user terminals, generating content for distribution to a processing target user terminal of said plurality of user terminals, based on an action log, which includes a positional information of the processing target user terminal and time at which said processing target user terminal existed at said position, and a user attribute of a user of processing target user terminal and distributing said content thus generated to said processing target user terminal.

2. A mobile marketing method according to claim 1, whereby said mobile marketing server selects as a processing target user terminal a user terminal of said plurality of user terminals having an action log and a user attribute satisfying any one of a plurality of pre-established distribution rules.

3. A mobile marketing method according to claim 2, whereby said mobile marketing server selects as a processing target user terminal a user terminal that is a source of information request notification.

4. A mobile marketing method according to claim 1, whereby said user terminal sends its positional information to said mobile marketing server, and
said mobile marketing server, based on a position sent from said user terminal, manages an action log of said user terminal.

5. A mobile marketing method according to claim 1, whereby
a position detection means carried by said user of said user terminal sends a positional information of said user terminal to said mobile marketing server, and
said mobile marketing server manages an action log of said user terminal based on a positional information sent from said position detection means.

6. A mobile marketing method according to claim 1, whereby
said user terminal sends its characteristic identifier, and
said mobile marketing server manages an action log of said user terminal based on said received positional information and identifier of said user terminal.

7. A mobile marketing method according to claim 1, whereby said mobile marketing server
manages an action log, which includes positions of each one of said user terminals and times at which said respective user terminals existed at said positions,
analyzes, when an analysis request is received from an analysis terminal, a behavior of said user terminal based on said managed action log, and
sends analysis results to said analysis terminal.

8. A mobile marketing method according to claim 7, wherein said analysis request includes a content ID, whereby said mobile marketing server
manages an distribution log, which includes an identifier of a user that is a distribution destination, said distributed content ID and time of distribution of content, and
when there is notification of an analysis request, which includes said content ID, from said analysis terminal, analyzes a change in a user terminal behavior when content having said content ID is distributed, based on said manage action log and distribution log.

9. A mobile marketing method according to claim 1, wherein said user attribute includes a user age and gender.

10. A mobile marketing system comprising a mobile marketing server, capable of communication with a plurality of mobile user terminals, which generates content to be distributed to a processing target user terminal of said plurality of said processing target user terminals, based on an action log, which includes a positional information of the processing target user terminal and time at which said processing target user terminal existed at said position, and a user attribute of a user of processing target user terminal, and distributing said generated content to said processing target user terminal,
wherein said user terminal comprises a display unit, which displays content distributed thereto from said mobile marketing server.

11. A mobile marketing system according to claim 10, wherein said mobile marketing server comprises:
means for generating content to be distributed to said processing target user terminal, based on an action log, which includes a positional information of said processing target user terminal and a time at which said processing target user terminal existed at said position, and a user attribute of a user of said processing target user terminal;
means for distributing content, which distributes content generated by said content generation means to said processing target user terminal,
wherein said user terminal comprises an information receiving means, which receives content distributed from said mobile marketing server and displays said content on a display unit.

12. A mobile marketing system according to claim 11, wherein said mobile marketing server further comprises a distribution rule database, into which are registered a plurality of distribution rules, which include a user terminal action condition, a user attribute condition, and a content ID,
wherein said content generation means sets as a processing target user terminal a user terminal having an action log and user attribute that match any one of the distribution rules registered in the distribution rule database among a plurality of user terminals, and generates content to be distributed to said processing target user terminal based on a content ID contained in said distribution rule and matching said action log of and attribute of said processing target user terminal.

13. A mobile marketing system according to claim 12, wherein each said user terminal comprises an information requesting means, which gives notification of an information request to said mobile marketing server,
wherein said content generation means sets as a processing target user terminal a user terminal that was a source of said information request notification, and generates content for distribution to said processing target user terminal, based on a content ID in said distribution log matching said action log of and attribute of said processing target user terminal.

14. A mobile marketing system according to claim 11, wherein
each said user terminal comprises a position detection means, which detects a position of said each one of said user terminals and a position notification means, which gives notification to said mobile marketing server of a position detected by said position detection means,
and wherein said mobile marketing server comprises an action log database and an action log registering means, which registers into said action log database an action log, which includes a positional information, of which notification was made from said user terminal, an identifier of the source of said notification, and the time of notification.

15. A mobile marketing system according to claim 11, further comprising a position detection means, which is carried by a user of said user terminal, and which detects a position of said user terminal and notifies as mobile marketing server, wherein
said mobile marketing server comprises an action log database and an action log registering means, which registers into said action log database an action log, which includes a positional information, of which notification was made from said user terminal, an identifier of the source of said notification corresponding to said position detection means of said source of notification, and the time of notification.

16. A mobile marketing system according to claim 11, further comprising a terminal-resident position detection means, which is carried by a user of said user terminal, and which sends an identifier characteristic of said user terminal, wherein
said mobile marketing server comprises an infrastructure-resident position detection means, which detects a position of said user terminal, based on received position of an identifier sent from said terminal-resident position detection means, an action log database, and an action log registering means, which registers into said action log database an action log, which includes a position detected by said infrastructure-resident position detection means, an identifier received by said infrastructure position detection means, and the time of reception of said identifier.

17. A mobile marketing system according to claim 10, further comprising:
an analysis terminal, which notifies said mobile marketing server of an analysis request and which displays analysis results send from said mobile marketing server,
wherein said mobile marketing server manages an action log, which includes a position of said user terminal and a time at which said user terminal existed at said position, and which also, upon notification of an analysis request from said analysis terminal, analyzes a behavior of a user terminal, based on said managed action log, and sends analysis results to said analysis terminal.

18. A mobile marketing system according to claim 17, wherein
said analysis request includes a content ID, and
said mobile marketing server manages an action log, which includes a content ID of distributed content, an identifier of said user terminal of content distribution, and a time of distribution, and, upon notification of an analysis request including a content ID from said analysis terminal, analyzes a change in a behavior of a user terminal at the time of distribution of content of said content ID, based on said managed action log and distribution log, and sends analysis results to said analysis terminal.

19. A mobile marketing system according to claim 18, wherein said mobile marketing server comprises:
an action log database, into which is registered an action log, which includes positions of each user terminal and times at which said user terminals existed at said positions;
a distribution log database, into which is registered a distribution log, which includes content IDs of a distributed content, identifiers of user terminal, which being a destination of said distribution, and times of said distributions; and
means for analysis, which, upon notification of an analysis request including a content ID from said analysis terminal, analyzes a change in a behavior of a user terminal at the time of distribution of content having said content ID, based on the contents of said action log database and said distribution log database, and sends analysis results to said analysis terminal.

20. A mobile marketing system according to claim 17, wherein said analysis terminal comprises:
an analysis requesting means, which notifies said mobile marketing server of an analysis request, which includes a content ID; and
an analysis results receiving means, which receives analysis results from said mobile marketing server and displays analysis results on a display unit.

21. A mobile marketing system according to claim 10, wherein said user attributes includes the age and gender of a user.

22. A mobile marketing server comprising:
a content generation means, which generates content to distribute to a processing target user terminal of a plurality of user terminals with which it can communicate, based on an action log, which includes a positional information of the processing target user terminal and time at which said processing target user terminal existed at said position, and a user attribute of a user of processing target user terminal; and
a means for distributing content generated by said content generation means to said processing target user terminal.

23. A mobile marketing server according to claim 22, further comprising:
an action log database, into which is registered an action log, which includes positional information of said user terminals and times at which said user terminals existed at said positions;
a distribution log database, into which are registered content IDs of distributed content, identifiers of user terminals to which distribution was done, and times of distributions; and
an analysis means, which, upon notification from an analysis terminal of an analysis request, which includes a content ID, analyzes a change in a behavior of a user terminal at a time of distribution of content of said content ID, based on contents of said action log database and said distribution log database, and which sends analysis results to said analysis terminal.

24. A user terminal comprising:
means for detecting its own terminal position;
means for notification of a position detected by said position detection means to a mobile marketing server;
means for requesting information which notifies said mobile marketing server of said information request; and
means for receiving information, which receives content sent from said mobile marketing server and displays said content on a display unit.

25. An analysis terminal comprising:
an analysis request notification means, which notifies a mobile marketing server of an analysis request; and
an analysis result receiving means, which receives analysis results sent from said mobile marketing server and displays said results on a display unit.

26. A program for causing a computer for a mobile marketing server to perform processing so as to generate content to be distributed to a processing target user terminal among a plurality of user terminals capable of communication with said computer, based on an action log, which includes a position of said processing target user terminal and a time at which said processing target user terminal existed at said position, and a user attribute of a user of said processing target user terminal, and processing so as to distribute said generated content to said processing target user terminal.

27. A program according to claim 26, which further causes said computer for a mobile marketing server to perform processing so as to manage an action log, which includes positions of said user terminals and times at which said user terminals existed at said positions, and a distribution log, which includes content IDs of distributed content, identifiers of a user terminal distribution source, and times of content distribution, wherein upon notification from said analysis terminal of an analysis request including a content ID, processing is performed to analyze a change in a behavior of a user terminal at the time of distribution of content of said ID, based on said managed action log and said managed distribution log.

28. A mobile marketing method according to claim 2, further comprising means for said mobile marketing server receiving a request for a distribution rule change from an analysis terminal and changing a distribution rule.
